(19) United States
(12) Patent Application Publication
(10) Pub. No.: US 2011/0063679 A1
(43) Pub. Date: Mar. 17, 2011

(54) IMAGE PROCESSING APPARATUS

(76) Inventors: Yasufumi AOYAMA, Tokyo (JP); Fumihito AKIYAMA, Yokohama-shi (JP); Masahiro OZAWA, Tokyo (JP); Jun KUROKI, Superior, CO (US); Hiroshi NOGAWA, Tokyo (JP); Kunikazu SATOU, Tokyo (JP); Takahisa MATSUNAGA, Tokyo (JP)

(21) Appl. No.: 12/879,904

(22) Filed: Sep. 10, 2010

(30) Foreign Application Priority Data
Sep. 16, 2009 (JP) 2009-214448

(51) Int. Cl. H04N 1/21; H04N 1/60

(52) U.S. Cl. 358/1.16; 358/1.9

(57) ABSTRACT

Disclosed is an image processing apparatus to generate printing data, comprising: a storage section to store the image data and reference data; a printing data generating section to generate the printing data based on the image data and the reference data; and a control section to output an address of the image data and that of the reference data to the printing data generating section, wherein the printing data generating section obtains the data based on the addresses thereof, and stores them in an internal storage section of the printing data generating section, and the control section outputs both of the addresses thereof when storage content stored in the internal storage section does not include the reference data obtained based on the address thereof, and only outputs the address of the image data when the storage content already includes the reference data obtained based on the address thereof.

### CROSS-REFERENCE TO RELATED APPLICATION

The present U.S. patent application claims a priority under the Paris Convention of Japanese patent application No. 2009-214448 filed on Sep. 16, 2009, which shall be a basis of correction of an incorrect translation.

### BACKGROUND OF THE INVENTION

1. Field of the Invention

The present invention relates to an image processing apparatus.

2. Description of the Related Art

In recent years, a further price-reduction of an image forming apparatus, such as a multi function peripheral (MFP) and a printer, has been required. Thereby, there has been necessity of developments directed to products placing more emphasis on lowering the cost thereof. As a technique for suppressing the cost to be lowered, one may adopt a less expensive central processing unit (CPU) to be mounted on an image forming apparatus. However, such a less expensive CPU tends to have lower computing performance, which causes reduction in computing speed. Accordingly, the performance degradation in the image forming apparatus, such as the slowdown of the operation thereof would occur, when simply using such a less expensive CPU.

By the way, a method of reducing the load of a CPU to be used for image processing in an image forming apparatus is disclosed in Japanese Patent Application Laid-Open Publication No. 2008-137278. Japanese Patent Application Laid-Open Publication No. 2008-137278 teaches a method to divide the image data of a printing object, and to perform the image processing of a part of the image data with a built-in CPU or the like and the image processing of the other part with an external personal computer (PC).

It is apprehended, however, that the method described in Japanese Patent Application Laid-Open Publication No. 2008-137278 causes the decrease of image processing speed in some cases. For example, if an image forming apparatus and a PC are connected to each other through a network, the time necessary for data transfer processing between both of them depends on the traffic of the network, and overhead owing to the data transfer processing occurs, which overhead elongates the time. In addition, because the PC is not an apparatus provided only for performing image processing but sometimes performs other processing, the increase of the processing time for the image processing is inevitable when the PC parallely performs the image processing and the other processing, which increase also elongates the time.

On the other hand, as another method of reducing the load of a CPU, the method of realizing the increase of processing speed by reducing the processing load of a CPU by making dedicated hardware, i.e. a digital signal processor (hereinafter, referred to as “DSP”), perform a part of image processing was devised.

Only the replacement of the processing executed by the CPU through software with the processing by the DSP, however, cannot realize the increase of the speed of the processing and the reduction of costs.

As a reason why the increase of the speed of processing cannot be realized, it can be given that the performance of image processing is accompanied by the input and output of a large quantity of data between a memory of an image forming apparatus and a local memory in a DSP. To put it concretely, because the traffic of data between the memory of the image forming apparatus and the local memory in the DSP increases and the time necessary for data transfer is elongated to lower the processing speed, it cannot be desired to increase the speed of processing.

As a reason why the reduction of cost cannot be achieved, it can be given that the necessity of making the local memory in the DSP have a large capacity occurs in order to perform the aforesaid input and output of a large quantity of data between the memory of the image forming apparatus and the local memory in the DSP. A DSP having a local memory of a large capacity is expensive, and the expensive DSP offsets the reduction of costs by using such DSP.

### SUMMARY OF THE INVENTION

The present invention was made in consideration of the resources situation mentioned above, and aims to realize image processing capable of coping with the cost reduction and the speeding-up of processing at the same time.

To achieve at least one of the abovementioned objects, an image processing apparatus to generate printing data based on image data, reflecting one aspect of the present invention comprises:

a storage section to store the image data and reference data necessary for processing of generating the printing data;

a printing data generating section to generate the printing data based on the image data and the reference data; and

a control section to output an address of the image data in the storage section and an address of the reference data in the storage section to the printing data generating section, wherein

the printing data generating section obtains the image data and the reference data based on the address of the image data and the address of the reference data, the address of the image data and the address of the reference data being output from the control section, and stores the obtained image data and the obtained reference data in an internal storage section of the printing data generating section, and

the control section outputs both of the address of the image data and the address of the reference data to the printing data generating section when storage content stored in the internal storage section does not include the reference data obtained based on the address of the reference data, and only outputs the address of the image data to the printing data generating section when the storage content stored in the internal storage section already includes the reference data obtained based on the address of the reference data.

Preferably, the control section outputs both of the address of the image data and the address of the reference data to the printing data generating section when the reference data stored in the internal storage section is not the same as the reference data obtained based on the address of the reference data, and only outputs the address of the image data to the printing data generating section when the reference data stored in the internal storage section is the same as the reference data obtained based on the address of the reference data.

Preferably, the control section generates management data for managing the data stored in the internal storage section, and judges whether the reference data stored in the internal storage section based on the management data and the reference data obtained based on the address of the reference data are the same or not.

To achieve at least one of the abovementioned objects, an image processing apparatus to generate printing data based on image data, reflecting another aspect of the present invention comprises:

a storage section to store the image data and reference data necessary for processing of generating the printing data;

a printing data generating section to generate the printing data based on the image data and the reference data; and

a control section to output an address of the image data in the storage section and an address of the reference data in the storage section to the printing data generating section, wherein

the printing data generating section obtains the image data and the reference data based on the address of the image data and the address of the reference data, the address of the image data and the address of the reference data being output from the control section, and stores the obtained image data and the obtained reference data in an internal storage section of the printing data generating section, and further adjusts a quota of a storage capacity for storing the reference data in the internal storage section based on data quantities of the image data and the reference data.

Preferably, the reference data is provided by each attribute of the image data, and

the control section outputs the address of the image data and the address of only the reference data corresponding to the attribute of the image data to the printing data generating section.

Preferably, the control section outputs the address of the image data and the address of only the reference data corresponding to color information of the image data to the printing data generating section.

Preferably, the control section outputs the address of the image data and the address of only the reference data corresponding to a kind of rendering content rendered based on the image data to the printing data generating section.

### BRIEF DESCRIPTION OF THE DRAWINGS

The present invention will become more fully understood from the detailed description given hereinbelow and the appended drawings, and thus are not intended as a definition of the limits of the present invention, wherein;

FIG. 1 is an explanatory view showing a network configuration diagram including image forming apparatuses each having an image processing apparatus according to the present invention;

FIG. 2 is a block diagram showing the main configuration of a computer;

FIG. 3 is a block diagram showing the main configuration of the image processing apparatus;

FIG. 4 is a functional block diagram showing an example of the processes and functions of the image processing by the image forming apparatus;

FIG. 5 is an explanatory view showing examples of the storage regions of a memory and a local memory of a DSP when image data and half-tone tables are copied from the memory to the local memory;

FIG. 6 is an explanatory view showing an example of the storage region of the local memory after printing data generation;

FIG. 7 is an explanatory view showing examples of the storage regions of the memory and the local memory of the DSP when the printing data is copied from the local memory to the memory;

FIG. 8 is an explanatory view showing examples of the storage regions of the memory and the local memory when the half-tone tables are not copied;

FIG. 9 is an explanatory view showing examples of the storage regions of the memory and the local memory when image data of one of the colors cyan (C), magenta (M), yellow (Y), and black (K) and half-tone tables corresponding to the respective pieces of image data are copied;

FIG. 10 is an explanatory view showing a comparative example between the storage region of the local memory when the image data and the half-tone tables of all colors are copied and the storage region of the local memory when the image data of one of the colors C, M, Y, and K and the half-tone tables corresponding to the image data are copied;

FIG. 11 is an explanatory view showing examples of the storage regions of the memory and the local memory when the image data of one kind of object and the half-tone tables corresponding to the image data are copied;

FIG. 12 is an explanatory view showing a comparative example between the storage region of the local memory when the half-tone tables corresponding to all kinds of the objects are copied and the storage region of the local memory when the half-tone tables corresponding to one kind of the objects are copied;

FIG. 13 is an explanatory view showing a comparative example between the storage region of the local memory when image data is copied as the image data using a half of a page of a predetermined paper size and the storage region of the local memory when the image data using the whole page of the paper size of a half page of the predetermined paper size is copied;

FIG. 14 is a flow chart showing the flow of rasterization processing and half-tone processing including copying control processing of half-tone tables on the basis of a transfer data list 65;

FIG. 15 is a flow chart showing the flow of the rasterization processing and the half-tone processing including the copying control processing of the half-tone tables based on the color information of image data;

FIG. 16 is a flow chart showing the flow of the rasterization processing and the half-tone processing including the copying control processing of the half-tone tables based on the kinds of objects of the image data; and

FIG. 17 is a flow chart showing the flow of the rasterization processing and the half-tone processing including the processing of securing a storage region of the local memory according to the paper size necessary for the formation of an image based on the image data.

### DETAILED DESCRIPTION OF THE PREFERRED EMBODIMENTS

In the following, an example of the embodiment of the present invention will be described in detail with reference to the accompanying drawings.

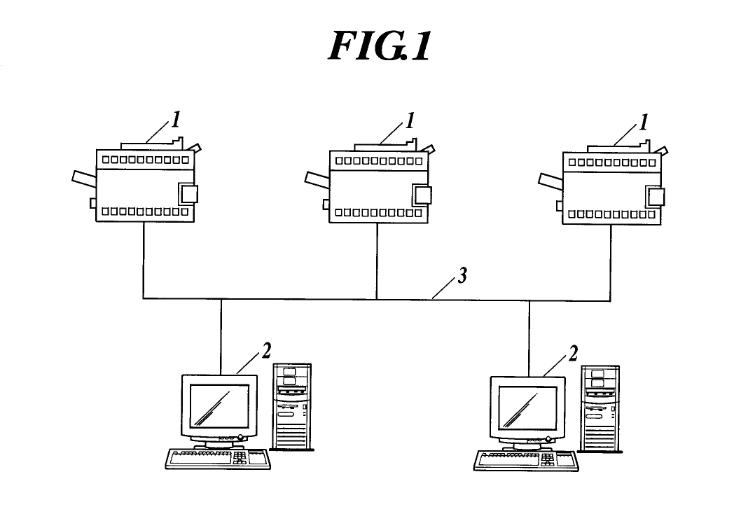

FIG. 1 shows a network configuration diagram including image forming apparatuses 1 each having an image processing apparatus according to the present invention.

The image forming apparatuses 1 are respectively connected to computers 2 communicably through a line 3.

The line 3 constitutes a network composed of the image forming apparatuses 1 and the computers 2. The line 3 may take any form as long as the line 3 communicably connects the computers 2 and the image forming apparatuses 1 with one another. For example, the line 3 may any one of, or a combination of a plurality of, wired connection lines, such as Ethernet (registered trade mark), a coaxial cable, and an optical fiber, the lines in conformity with various standards for realizing wireless communication, and the like. Furthermore, the line 3 is independent of the network scale thereof, such as those of a local area network (LAN) and the Internet.

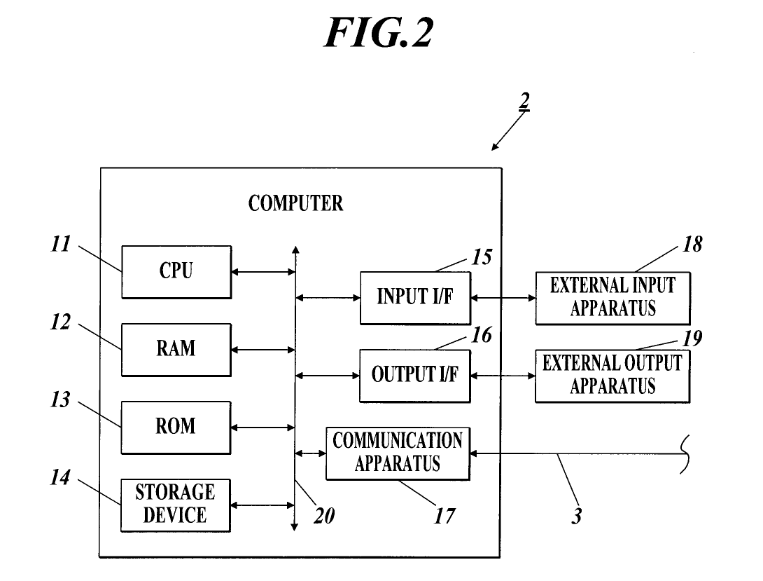

FIG. 2 shows the main configuration of each of the computers 2.

Each of the computers 2 includes a CPU 11, a random access memory (RAM) 12, a read only memory (ROM) 13, a storage device 14, an input interface (I/F) 15, and output I/F 16, and a communication apparatus 17. The CPU 11, the RAM 12, the ROM 13, the storage device 14, the input I/F 15, the output I/F 16, and the communication apparatus 17 are connected to one another with a bus 20.

The CPU 11 reads out a program, data, and the like corresponding to processing content from the ROM 13 or the storage device 14 and processes them to perform the various pieces of processing of the computer 2 and the operation control of the respective sections of the computer 2.

The RAM 12 functions as a primary storage apparatus storing the program, the data, and the like to be read out in processing executed by the CPU 11, and storing data, parameters, and the like generated by the processing.

The ROM 13 stores a program, data, and the like read out by the CPU 11 in a non-rewritable state.

The storage device 14 is, for example, a hard disk or a flash memory, and stores the program, data, and the like that are read out by the CPU 11 in a rewritable state.

The input I/F 15 is an interface to receive input by an input apparatus, such as an external input apparatus 18. The external input apparatus 18 is, for example, a keyboard and a mouse and performs an input instruction by a user's manual operation.

The output I/F 16 is an interface to perform output to an output apparatus, such as an external output apparatus 19. The external output apparatus 19 is, for example, a display apparatus, such as a cathode ray tube (CRT) and a liquid crystal display, and displays an output screen based on a processing result of the CPU 11.

The communication apparatus 17 connects the computer 2 to an external communication line (e.g. line 3) to enable the computer 2 to communicate with external equipment. The communication apparatus 17 is, for example, a network interface card (NIC), and a device enabling the connection according to the kind of the communication line can be used as the communication apparatus 17.

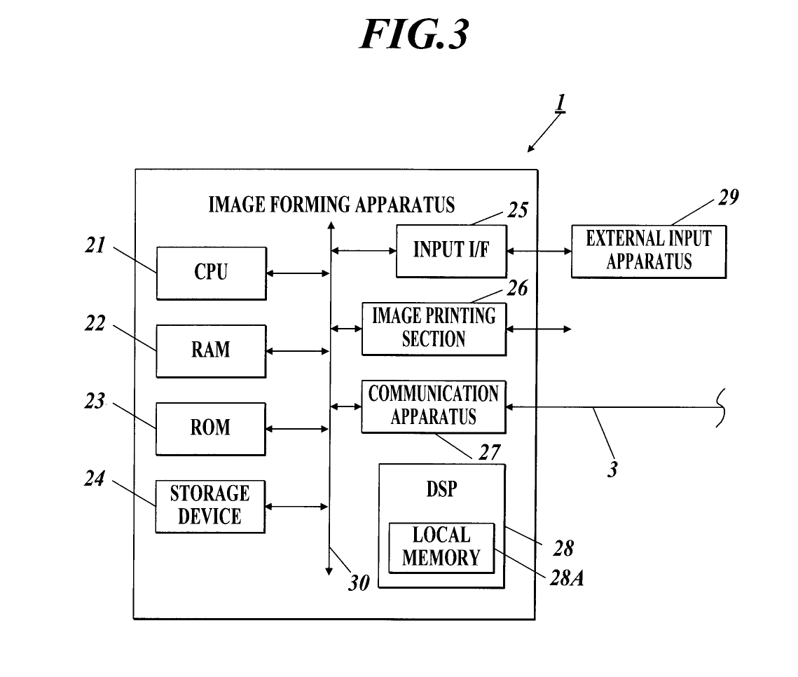

FIG. 3 shows the main configuration of each of the image forming apparatuses 1. Because the image forming apparatuses 1 all have the same configurations, one of them will be described in the following.

The image forming apparatus 1 is equipped with a CPU 21, a RAM 22, a ROM 23, a storage device 24, an input I/F 25, an image printing section 26, a communication apparatus 27, and a DSP 28. The CPU 21, the RAM 22, the ROM 23, the storage device 24, the input I/F 25, the image printing section 26, the communication apparatus 27, and the DSP 28 are connected to one another with a bus 30.

The CPU 21 reads out a program, data, and the like corresponding to processing content from the ROM 23 or the storage device 24 and processes them to perform the various kinds of processing of the image forming apparatus 1 and the operation control of the respective sections of the image forming apparatus 1.

The RAM 22 functions as a primary storage apparatus storing the program, the data, and the like to be read out in processing executed by the CPU 21, and storing data, parameters, and the like generated by the processing.

The ROM 23 stores a program, data, and the like read out by the CPU 21 in a non-rewritable state.

The storage device 24 is, for example, a hard disk or a flash memory, and stores a program, data, and the like that are read out by the CPU 21 in a rewritable state.

The input I/F 25 is an interface receiving the input by an input apparatus, such as an external input apparatus 29. The external input apparatus 29 is, for example, an input panel, including a touch panel display, and performs an input instruction by a user's manual operation.

The image printing section 26 is an engine for forming an image on a printing medium, such as paper, on the basis of printing data 63, described below.

The communication apparatus 27 connects the image forming apparatus 1 to an external communication line (e.g. line 3) to enable the image forming apparatus 1 to communicate with external equipment. The communication apparatus 27 is, for example, a NIC, and a device enabling the connection according to the kind of the communication line can be used as the communication apparatus 27.

The DSP 28 is a digital signal processor for performing half-tone processing. The DSP 28 is, for example, an application specific integrated circuit (ASIC), and the DSP 28 of the present embodiment is dedicated hardware performing the half-tone processing. The rendering processing performed by the DSP 28 will be described later.

The DSP 28 includes a local memory 28A as an “internal storage, section”. The DSP 28 performs processing by using a storage region in the local memory 28A at the time of reading out data or performing the half-tone processing.

The DSP 28 is provided to the image forming apparatus 1 in a detachably attachable state. Although the number of the DSPs 28 shown in FIG. 3 is one, a plurality of DSPs 28 can be provided to the image forming apparatus 1. If a plurality of DSPs 28 is provided to the image forming apparatus 1, the plurality of DSPs 28 can share processing.

Next, the image processing by the image forming apparatus 1 will be described.

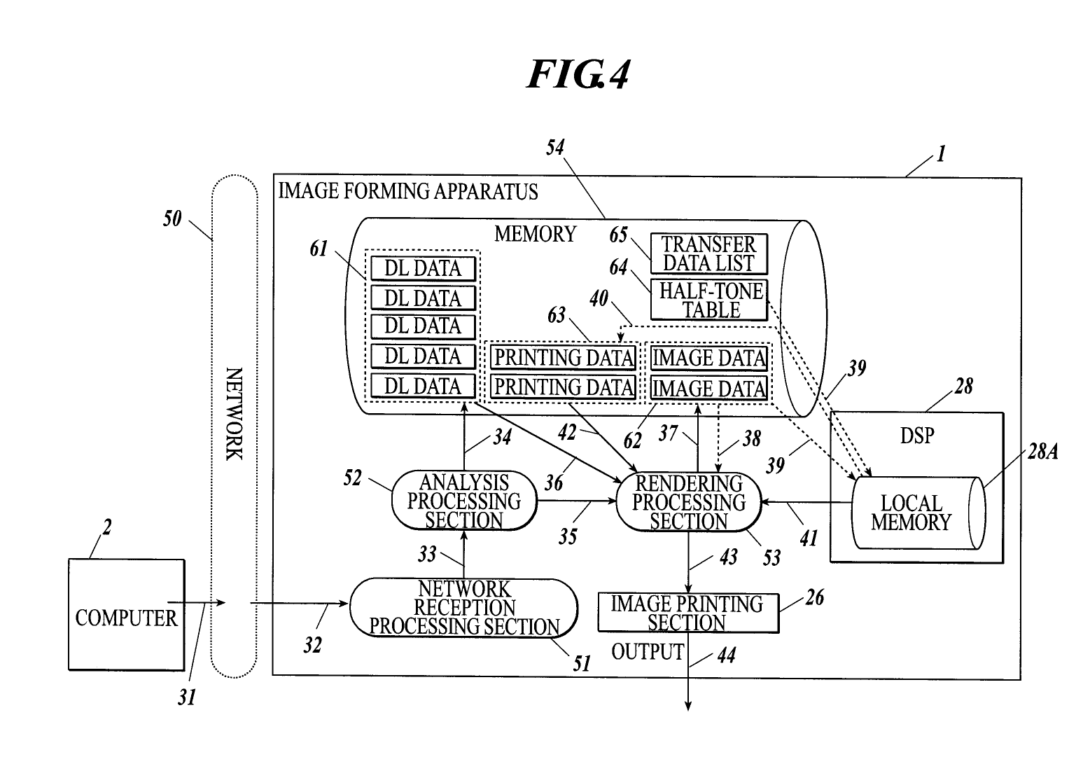

FIG. 4 shows an example of processes and functions of image processing by the image forming apparatus 1.

First, one of the computers 2 transmits a printing job (31 in FIG. 4).

The printing job is transferred through a network 50, and is received by a network reception processing section 51 of the image forming apparatus 1 (32 in FIG. 4). The network 50 is constructed by the communication connection of the computers 2 and the image forming apparatuses 1 with the line 3. The network reception processing section 51 is a function by the communication apparatus 27 of the image forming apparatus 1.

The printing job received by the network reception processing section 51 is input into an analysis processing section 52 (33 in FIG. 4) and is subjected to analysis processing by the analysis processing section 52. By the analysis processing, intermediate language data (e.g. display list (DL) data 61 in the present embodiment) is generated on the basis of a page description language (hereinafter referred to as “PDL”) included in the printing job. The analysis processing section 52 functions by reading out a program, data, and the like for the CPU 21 to perform the analysis processing from the ROM 23 or the storage device 24 to execute and process the read program, data, and the like.

The analysis processing section 52 stores the DL data 61 generated by the analysis processing into a memory 54 (34 in FIG. 4). The memory 54 as the “storage section” in the present embodiment indicates a storage region used as a virtual memory collectively including the storage regions of the RAM 22 and the storage device 24.

When the DL data 61 corresponding to the printing content for one page is stored in the memory 54, the processing moves from that by the analysis processing section 52 to that by a rendering processing section 53 (35 in FIG. 45). The rendering processing section 53 performs rasterization processing on the basis of the DL data 61. In addition, the printing content for one page, for example, indicates the printing content or the like for one page of paper of a predetermined size (e.g. A4).

The rendering processing section 53 functions by reading out the program, data, and the like corresponding to the processing content from the ROM 23 or the storage device 24 to execute and process the read-out program, data, and the like with the CPU 21.

In the rasterization processing, image data 62 is generated on the basis of the DL data 61. To put it concretely, in the rasterization processing, the image data 62 is generated by the performance of the rendering processing of an object based on the DL data 61 to a rendering region in a predetermined range. A piece of image data 62 is sometimes generated on the basis of a plurality of pieces of DL data 61. The image data 62 is the image data (bitmap data) generated on the basis of the DL data 61. The rendering processing section 53 reads out the DL data 61 from the memory 54 (36 in FIG. 4), and performs the rasterization processing of the DL data 61 to generate the image data 62. After the generation of the image data 62, the rendering processing section 53 stores the image data 62 in the memory 54 (37 in FIG. 4).

The rasterization processing is performed by the band or by the page. The printing content for one page is composed of a plurality of bands. Each band is composed of a plurality of lines.

A line is a set of pixels constituting an image, which pixels are arranged in a predetermined direction (for example, the lateral direction of the image). An image is composed by combining lines arranged in the direction (for example, the longitudinal direction of the image) perpendicular to the predetermined direction. A band is a set of a plurality of lines, and the printing content for one page is a set of a plurality of bands.

In the present embodiment, rasterization processing is performed by the band.

After rasterization processing, the rendering processing section 53 makes the DSP 28 perform half-tone processing. The half-tone processing is the processing of generating the printing data 63 on the basis of the image data 62, which is the original image data, and a half-tone table 64, which is reference data. The printing data 63 is the data for printing having optimized color values, which data enables the printing output by the image printing section 26 without requiring any more working and processing.

The rendering processing section 53 inputs the memory address of the image data 62 of an object of half-tone processing and the memory address of the half-tone table 64 to be used for the half-tone processing into the DSP 28 (38 in FIG. 4). The memory address is an address for obtaining data, and the DSP 28 reads out the image data 62 and the half-tone table 64 from the memory 54 on the basis of the memory address of the image data 62 and the memory address of the half-tone table 64, respectively.

The DSP 28 copies the read-out image data 62 and the half-tone table 64 into the local memory 28A (39 in FIG. 4). Then, the DSP 28 performs the half-tone processing to generate the printing data 63. The generated printing data 63 is stored in the local memory 28A. After the generation of the printing data 63, the DSP 28 writes out the printing data 63 from the local memory 28A to the memory 54 (40 in FIG. 4). Then, the DSP 28 informs the rendering processing section 53 of the completion of the half-tone processing (41 in FIG. 4).

The generation processing of the printing data 63 in the present embodiment is performed by the page.

The printing data 63 stored in the memory 54 is read out by the rendering processing section 53 (42 in FIG. 4), and is input into the image printing section 26 (43 in FIG. 4) to be subjected to printing output (44 in FIG. 4). When the printing output of the printing data 63 ends, the DL data 61, the image data 62, and the printing data 63 corresponding to the content subjected to the printing output is eliminated from the memory 54.

If the printing content of a printing job ranges over a plurality of pages, the processing on and after the analysis processing is repeated according to the number of pages.

As described above, the CPU 21 of the image forming apparatus 1 reads out and executes the program, the data, and the like corresponding to processing content from the ROM 23 or the storage device 24, and processes the read program, data, and the like. Thereby, the CPU 21 functions as the analysis processing section 52 and the rendering processing section 53, mentioned above. Namely, the CPU 21, the RAM 22, and the ROM 23 or the storage device 24; or the CPU 21, the RAM 22, the ROM 23, and the storage device 24 function as an image processing apparatus in cooperation with one another.

In addition, the flows of FIG. 4 and the aforesaid image processing are shown as outlines, and an actual operation may be different from them. For example, if printing ranges over a plurality of pages, the processing on and after the rasterization processing of a certain page and the analysis processing of the pages on and after the page to which the processing on and after the rasterization processing is being performed may be performed in parallel.

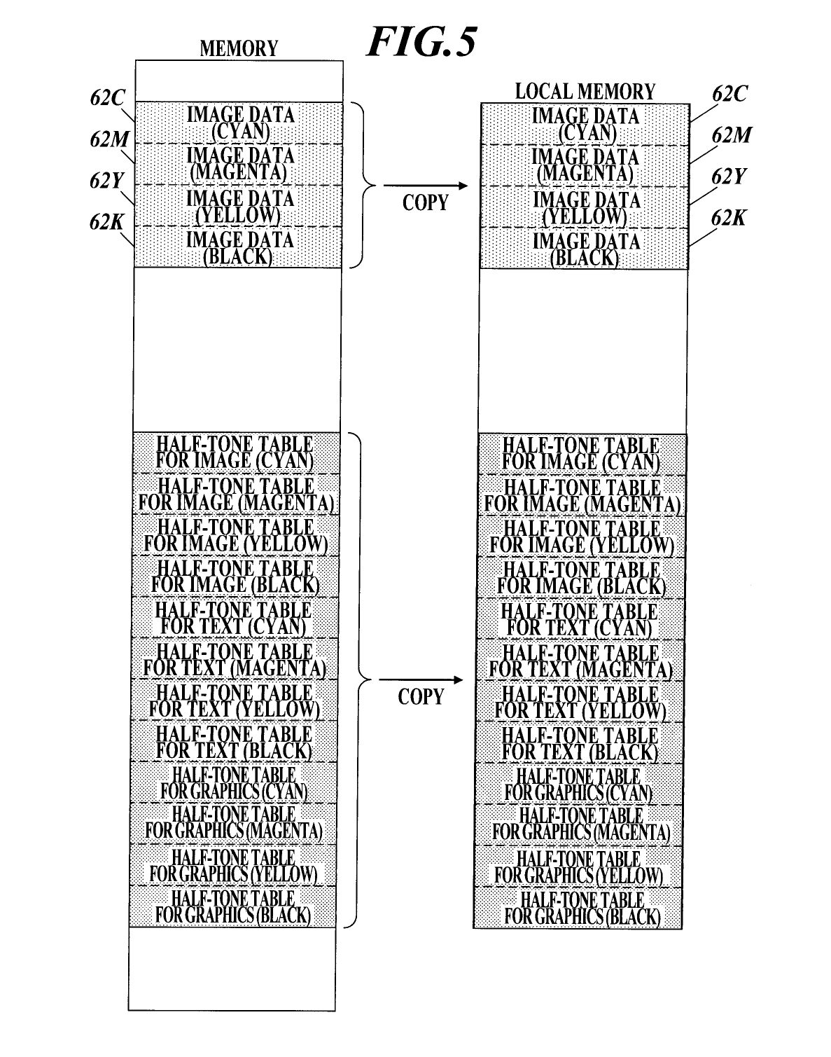

Next, half-tone processing will be described with reference to FIGS. 5-7.

FIG. 5 shows examples of the storage regions of the memory 54 and the local memory 28A when the image data 62 and the half-tone table 64 are copied from the memory 54 to the local memory 28A of the DSP 28.

As shown in FIG. 5, the image data 62 includes the color planes of the respective colors of the so-called C, M, Y, and K of cyan (C), magenta (M), yellow (M), and black (K), respectively, constituting an image. In the following description, the following notation is sometimes adopted that image data having only a color plane of cyan is denoted by image data 62C; image data having only a color plane of magenta is denoted by the image data 62M; image data having only a color plane of yellow is denoted by image data 62Y; and image data having only a color plane of black is denoted by image data 62K.

Furthermore, as shown in FIG. 5, the half-tone table 64 comprehends half-tone tables individually provided correspondingly to the combinations of the respective attributes of the kinds of objects and pieces of color information.

The kinds of objects are the attributes of image data indicating the kinds of the image data classified according to the rendering content of the image data. There are a text, graphics, and an image as the kinds of objects to be used in the present embodiment. Each piece of image data 62 corresponds to at least any one of these kinds of objects.

The color information of the half-tone table 64 corresponds to the color planes of the respective colors C, M, Y, and K included in the image data 62.

The various kinds of information, such as the color information of the image data 62 and the kinds of objects, are obtained by the CPU 21 during rasterization processing. To put it concretely, when the rendering processing section 53 generates the image data 62 on the basis of the DL data 61, the rendering processing section 53 obtains the color information and the kinds of objects included in the generated image data 62. In the following description, the processing of the CPU 21 for obtaining the color information and the kinds of objects of the image data 62 will sometimes be described as “set information obtaining processing”. In the set information obtaining processing, a paper size and the like necessary for forming an image based on the image data 62 are also obtained besides the color information and the kinds of objects of the image data 62.

The CPU 21 functioning as the rendering processing section 53 inputs the memory address of the image data 62 and the memory address at which the half-tone table 64 is stored into the DSP 28. The DSP 28 reads out the image data 62 and the half-tone table 64 corresponding to the memory addresses input from the CPU 21 to copy the read-out image data 62 and the half-tone table 64 into the local memory 28A.

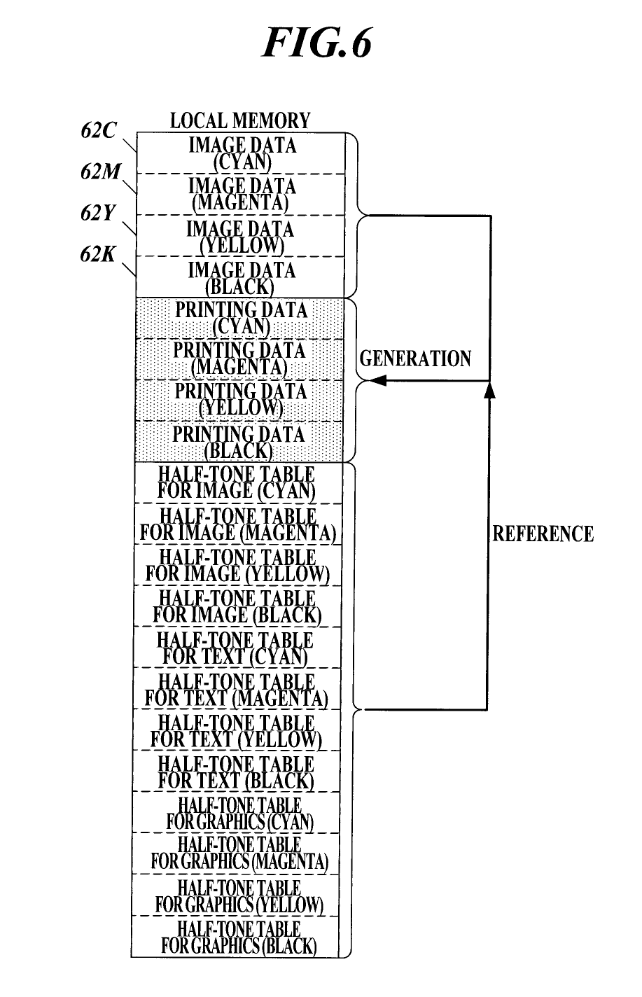

FIG. 6 shows an example of the storage region of the local memory 28A after the generation of the printing data 63.

The DSP 28 generates the printing data 63 on the basis of the image data 62 and the half-tone table 64 copied into the local memory 28A. The printing data 63 is individually generated as to the respective colors C, M, Y, and K.

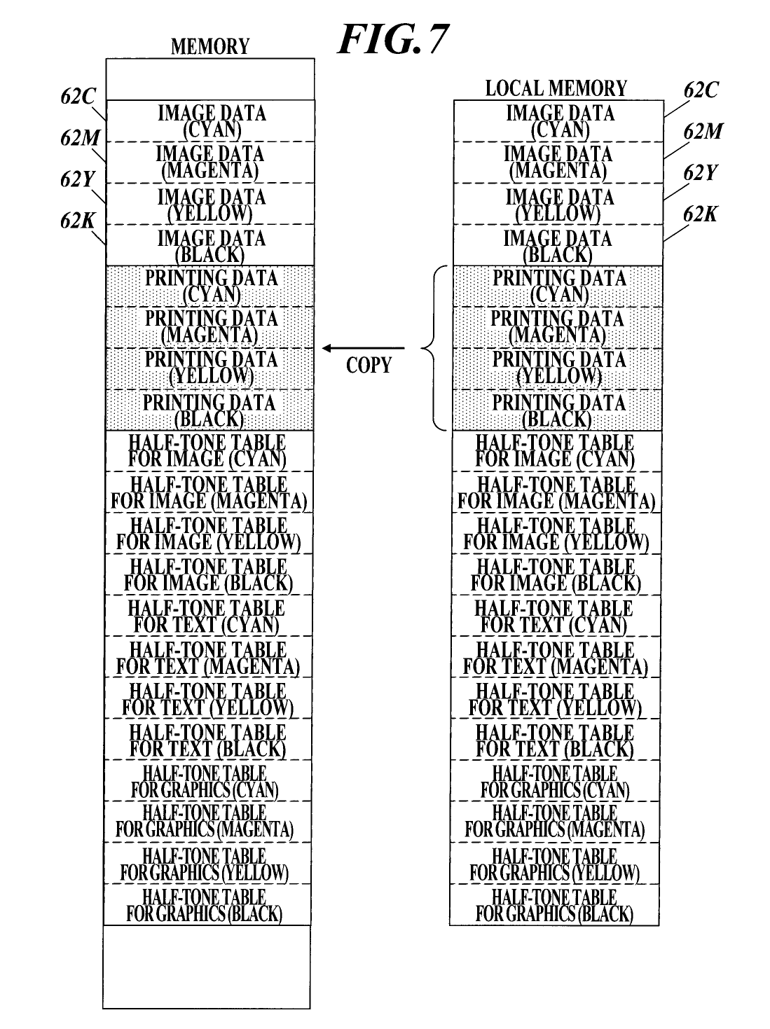

FIG. 7 shows examples of the storage regions of the memory 54 and the local memory 28A when the printing data 63 is copied from the local memory 28A of the DSP 28 to the memory 54.

The DSP 28 copies the generated printing data 63 from the local memory 28A to the memory 54. Then, the DSP 28 informs the rendering processing section 53 of the completion of the half-tone processing.

Although the description using FIGS. 5-7 describes the half-tone processing using the image data 62 comprehending the image data of all colors and the half-tone table 62 comprehending the combinations of all kinds of objects and all colors, the CPU 21 outputs the memory addresses for copying the requisite minimum of the half-tone table 64 according to the attributes of the image data 62 on which the half-tone processing is performed to the DSP 28.

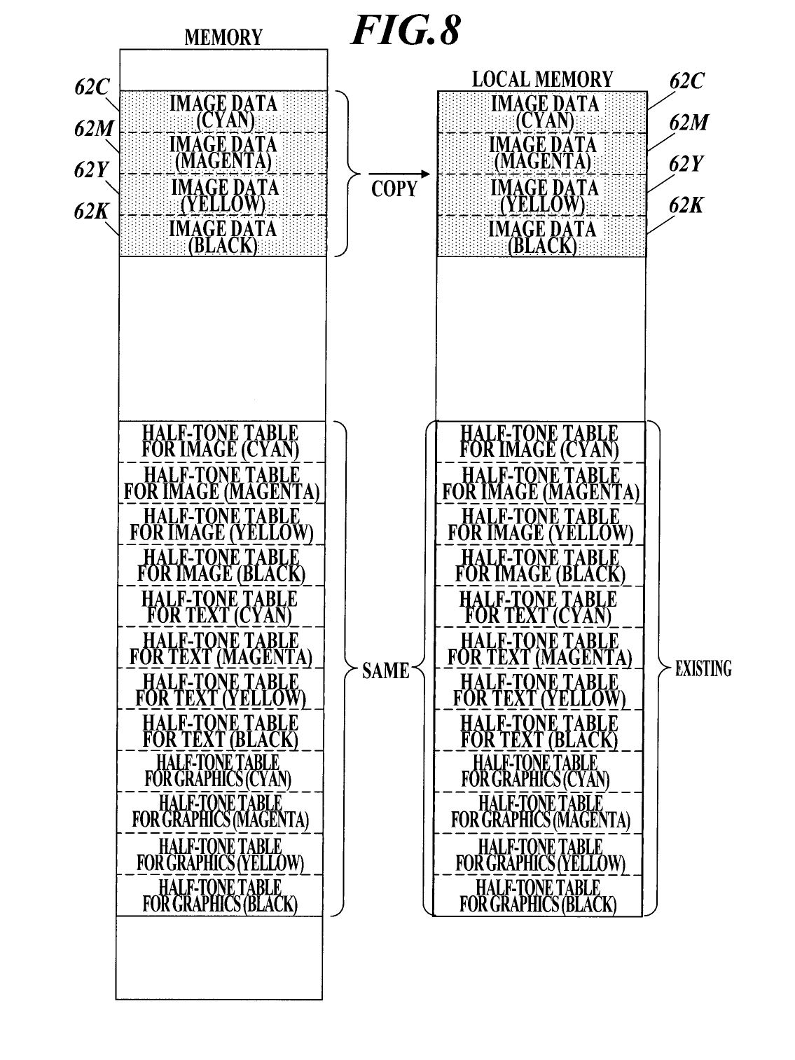

FIG. 8 shows examples of the storage regions of the memory 54 and the local memory 28A when the half-tone table 64 is not copied.

The CPU 21 only outputs the memory address of the image data 62 to the DSP 28 when the half-tone table 64 stored in the local memory 28A of the DSP 28 and the half-tone table 64 corresponding to the image data 62 of the object of the half-tone processing are the same.

The CPU 21 generates a transfer data list 65 when the CPU 21 outputs a memory address to the DSP 28. The transfer data list 65 indicates the data copied by the DSP 28 on the basis of the memory address output by the CPU 21.

The CPU 21 reads the transfer data list 65 therein and obtains the information of the data copied by the DSP 28 when the CPU 21 outputs the memory address of the image data 62 of the object of the half-tone processing and the memory address of the half-tone table 64 corresponding to the image data 62 to the DSP 28. Then, the CPU 21 judges whether the half-tone table 64 corresponding to the image data 62 of the half-tone processing to be performed from now on is the same one as the half-tone table 64 copied by the DSP 28 at the time of the half-tone processing before then or not. As the result of the judgment, if the half-tone table 64 corresponding to the image data 62 of the half-tone processing to be performed from now on is the same one as the half-tone table 64 copied by the DSP 28 at the time of the half-tone processing before then, the CPU 21 outputs only the memory address of the image data 62.

Because the DSP 28 obtains data on the basis of a memory address output from the CPU 21, the DPS 28 only obtains the image data 62 to copy the obtained image data 62 into the local memory 28A, and performs the half-tone processing with reference to the half-tone table already stored in the local memory 28A.

Hereby, the traffic of data and a data transfer time for obtaining the half-tone table 64 can be curtailed, and the processing time required for half-tone processing can be shortened. Namely, the increase of the speed of the half-tone processing can be realized.

In addition, although FIG. 8 and the description thereof have been given to the case where the half-tone table 64 stored in the local memory 28A and the half-tone table 64 corresponding to the image data 62 of the object of the half-tone processing are the same ones, the processing in the case where the storage content stored in the local memory 28A includes the half-tone table 64 corresponding to the image data 62 of the object of the half-tone processing is similar to that described above.

Furthermore, if the storage content stored in the local memory 28A does not include the half-tone table 64 corresponding to the image data 62 of the object of the half-tone processing, or if the storage content is not the same one as the half-tone table 64, then the CPU 21 outputs the memory address of the image data 62 and the memory address of the half-tone table 64 to the DSP 28.

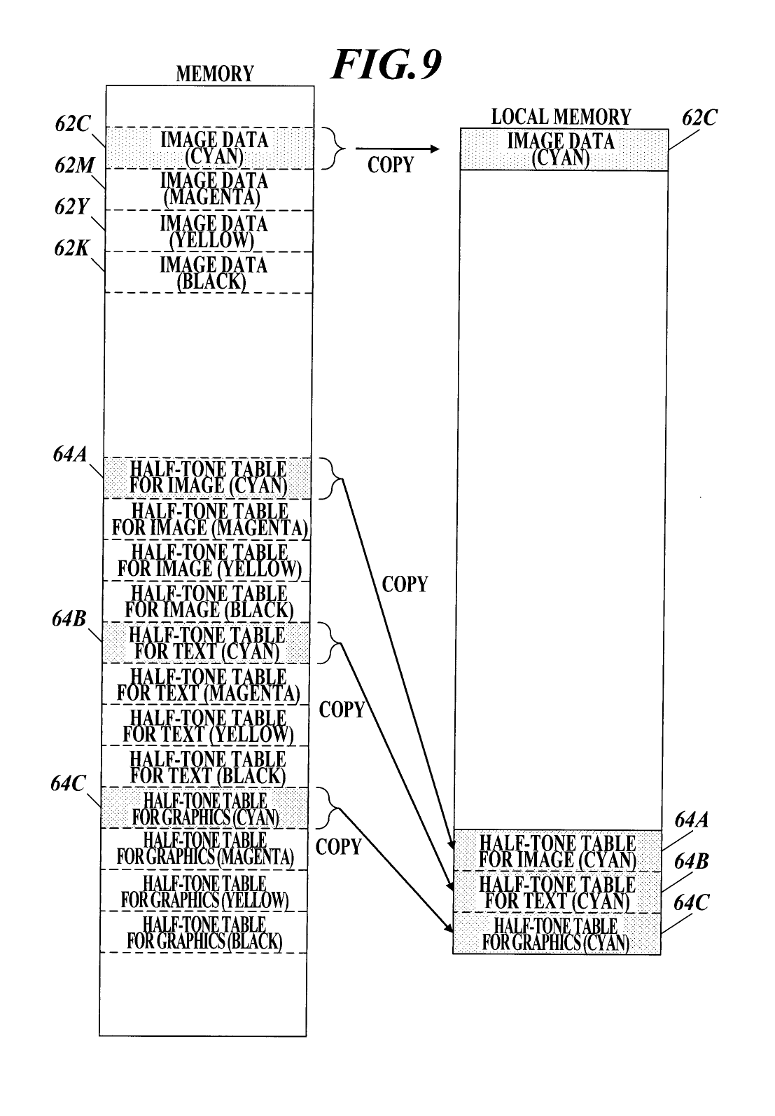

FIG. 9 shows examples of the storage regions of the memory 54 and the local memory 28A when the image data 62 of one of the colors C, M, Y, and K and the half-tone table 64 corresponding to the image data 62 are copied.

The CPU 21 outputs the memory address of the image data 62 of the object of the half-tone processing and the memory address of only the half-tone table 64 corresponding to the color information of the image data 62 to the DSP 28. The DSP 28 copies the image data 62 of the object of the half-tone processing and only the half-tone table 64 corresponding to the color information of the image data 62 to the local memory 28A.

Although the example of copying the cyan image data 62C and only the half-tone table 64 (half-tone tables 64A, 64B, and 64C shown in FIG. 9) for performing the half-tone processing to the cyan image data 62C is shown in the example shown in FIG. 9, the processing of the image data 62 and the half-tone table 64 of the other colors is also similar to that of the example. Furthermore, the number of the colors to be copied is not limited to one, but may be two or more.

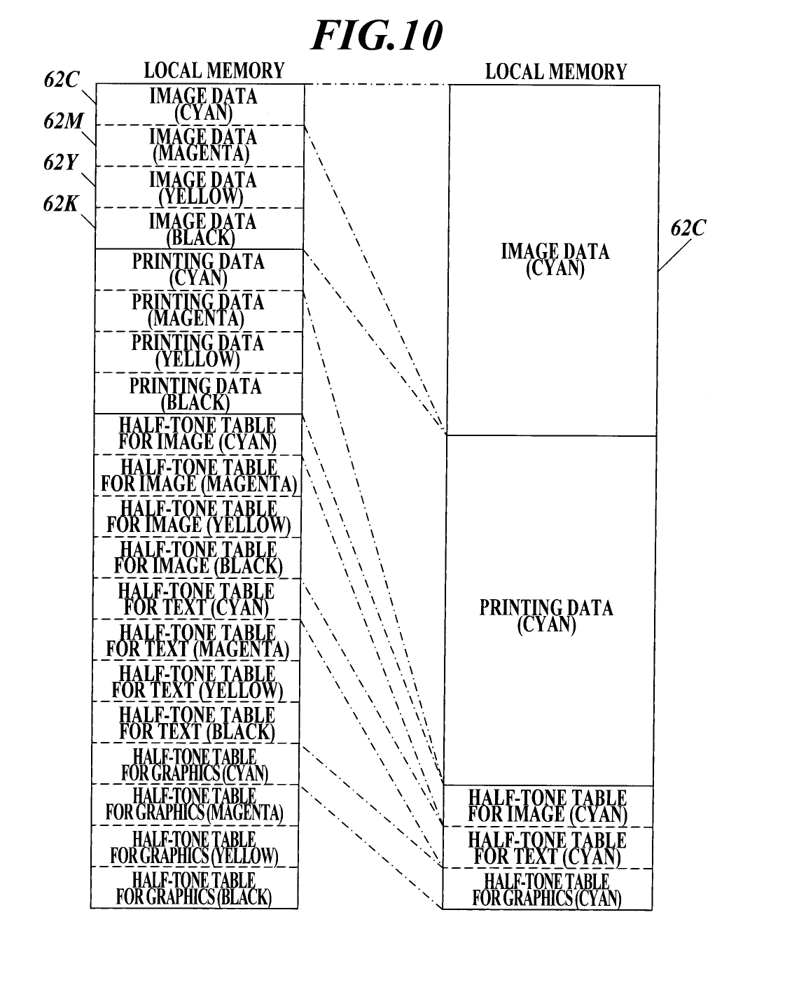

FIG. 10 shows an comparative example of the storage region of the local memory 28A when the image data 62 and the half-tone table 64 of all colors are copied, and the storage region of the local memory 28A when the image data 62 of one of the colors C, M, Y, and K and the half-tone table 64 corresponding to the image data 62 are copied.

As shown in FIG. 10, the DSP 28 adjusts the quota of the storage capacity for storing the half-tone table 64 in the local memory 28A on the basis of the data quantity of the image data 62 and the half-tone table 64 that become necessary correspondingly to the memory addresses input from the CPU 21. In addition, the DSP 28A adjusts the assignment of the storage capacity for storing the image data 62 and the printing data 63. To put it concretely, if the half-tone table 64 of one of the colors C, M, Y, and K is copied, the storage capacity necessary for storing the half-tone table 64 becomes smaller than that in the case of copying the half-tone table 64 of all the colors. Accordingly, when the DSP 28 performs the half-tone processing to the image data 62 of one of the colors C, M, Y, and K, the DSP 28 reduces the quota of the storage capacity of the local memory 28A for storing the half-tone table 64. Then, the DSP 28 assigns the part of the storage capacity of the local memory 28A for storing the half-tone table 64, which part corresponds to the reduced amount of the quota of the storage capacity of the local memory 28A, to the reading of the image data 62 and the storing of the generated printing data 63.

To put it concretely, the CPU 21 obtains the usable storage capacity of the local memory 28A through the DSP 28. Then, the CPU 21 obtains the data capacity of the image data 62 and the data capacity of the half-tone table 64 necessary for the half-tone processing of the image data 62, and determines the data capacity of the image data 62 of the copy object and the half-tone table 64 on the basis of the usable storage capacity of the local memory 28A. The CPU 21 outputs the memory addresses corresponding to the image data 62 of the determined data capacity and the half-tone table 64 to the DSP 28.

Hereby, the capacity of the image data 62 for which half-tone processing can be performed at a stretch can be made to be larger than that in the case of performing the half-tone processing requiring the half-tone table 64 of all colors. Consequently, the capacity of the image data 62 for which half-tone processing can be performed by the command for performing the half-tone processing can be made to be large, and the number of times of data transfers between the memory 54 and the local memory 28A in the processing of generating the printing data 63 by repeating a plurality of times of half-tone processing. Namely, the overhead accompanying the commands for performing the half-tone processing and the data transfers accompanying the half-tone processing can be reduced.

In addition, the traffic of data between the memory 54 and the local memory 28A can be reduced by not transferring the unnecessary half-tone table 64.

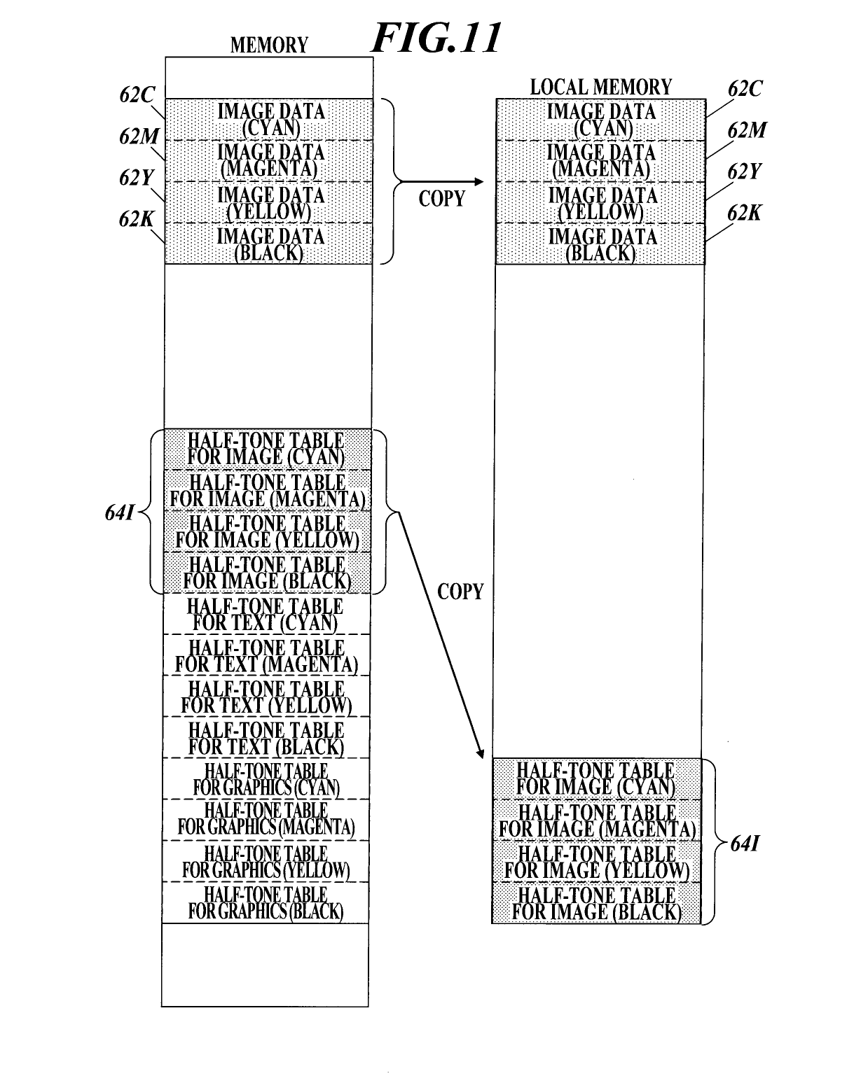

FIG. 11 shows examples of the storage regions of the memory 54 and the local memory 28A in the case of copying the image data 62 of one kind of object and the half-tone table 64 corresponding to the image data 62.

The CPU 21 outputs the memory address of the image data 62 of the object of the half-tone processing and the memory address of only the half-tone table 64 corresponding to the kind of object of the image data 62 to the DSP 28. The DSP 28 copies the image data 62 of the object of the half-tone processing and only the half-tone table 64 corresponding to the kind of object of the image data 62 to the local memory 28A.

Although the example of only copying the half-tone table (64I shown in FIG. 11) for performing the half-tone processing to the image data 62 of the kind of object of an image is shown as the example shown in FIG. 11, the processing of the image data 62 and the half-tone table 64 of the other kinds of objects, such as a text and graphics, is also similarly to that of that of the image. Furthermore, the object to be processed is not limited to one kind of object, but two or more kinds of objects may also be processed.

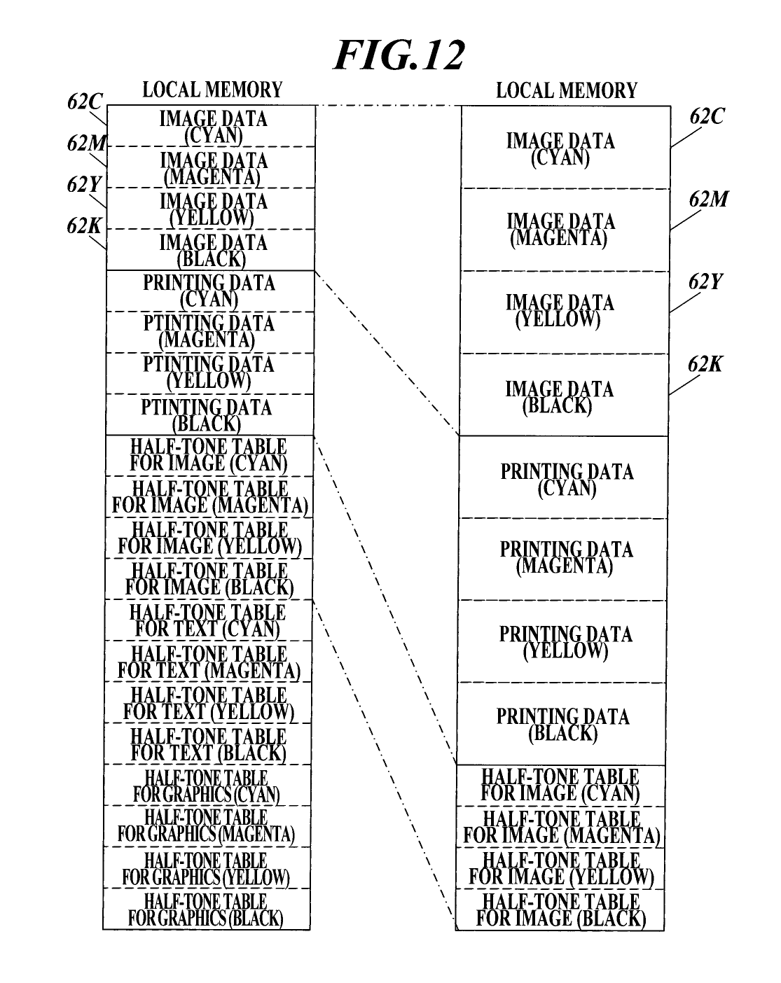

FIG. 12 shows a comparative example of the storage region of the local memory 28A when the half-tone table 64 corresponding to all kinds of objects is copied and the storage region of the local memory 28A when the half-tone table 64 corresponding to one kind of object is copied.

As shown in FIG. 12, the DSP 28 adjusts the quota of the storage capacity in the local memory 28A for storing the half-tone table 64 on the basis of the data quantity of the image data 62 and the half-tone table 64 which data quantity is required correspondingly to the memory addresses input from the CPU 21. In addition, the DSP 28 adjusts the assignment of the storage capacity for storing the image data 62 and the printing data 63. To put it concretely, if the half-tone table 64 corresponding to one kind of object is copied, the storage capacity necessary for storing the half-tone table 64 becomes smaller than that in the case where the half-tone table 64 corresponding to all kinds of objects is copied. Accordingly, if the DSP 28 performs the half-tone processing to the image data 62 corresponding to one kind of object, the DSP 28 reduces the quota of the storage capacity of the local memory 28A for storing the half-tone table 64. Then, the DSP 28 assigns the part of the storage capacity of the local memory 28A for storing the half-tone table 64 which part corresponds to the reduced amount of the quota of the storage capacity of the local memory 28A to the reading of the image data 62 and the storing of the generated printing data 63. The concrete processing of the CPU 21 is similar to that in the case of performing the half-tone processing to the image data 62 having only a part of the color planes.

Hereby, the capacity of the image data 62 for which the half-tone processing can be performed in a stretch can be made to be larger than that in the case of performing the half-tone processing requiring the half-tone table 64 corresponding to all kinds of objects. Consequently, the capacity of the image data 62 for which the half-tone processing can be performed by the command for performing the half-tone processing can be made to be large, and the times of data transfers between the memory 54 and the local memory 28A in the processing of generating the printing data 63 by repeating a plurality of times of half-tone processing can be reduced. Namely, the overhead accompanying the commands for performing half-tone processing and the data transfers accompanying the half-tone processing can be reduced.

In addition, the traffic of data between the memory 54 and the local memory 28A can be reduced by not transferring the unnecessary half-tone table 64.

Furthermore, the DSP 28 adjusts the assignment of the storage capacity for storing the image data 62 and the printing data 63 correspondingly to the printing size of the image data 62.

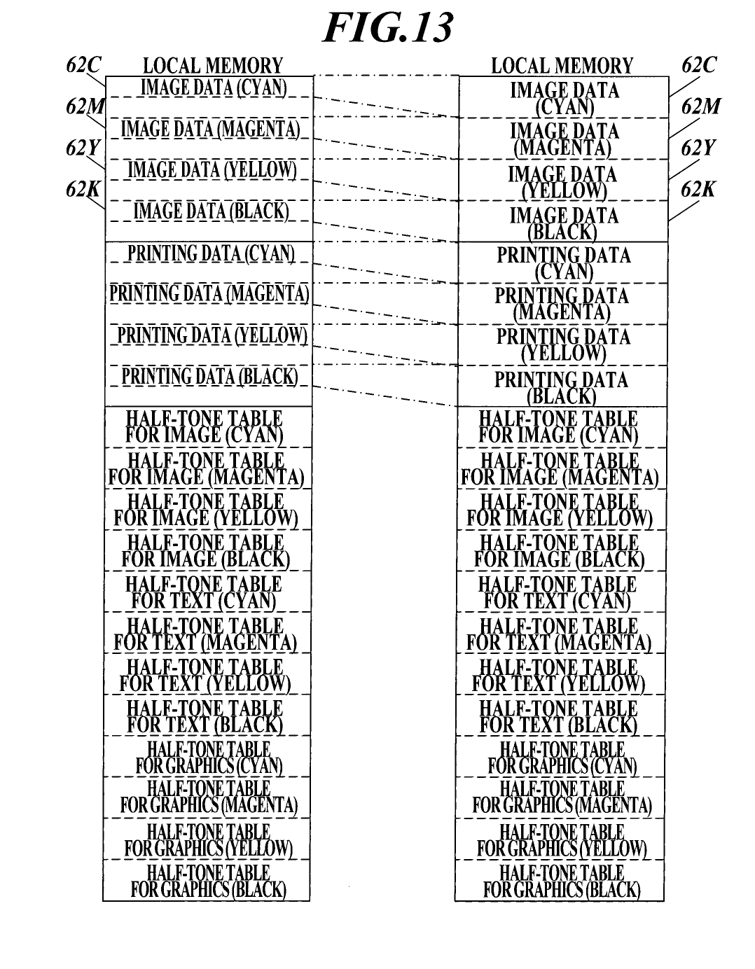

FIG. 13 shows a comparison example between the storage region of the local memory 28A at the time of copying the image data 62 as the image data 62 using a half of the page of a predetermined paper size and the storage region of the local memory 28A at the time of copying the image data 62 using the whole page of the half paper size of the predetermined paper size.

When the DSP 28 copies the image data 62, the DSP 28 secures the storage region corresponding to the paper size (e.g. A4) at the time of printing, which paper size has been set by a printer driver, application software, or the like, in the local memory 28A, and copies the image data 62 into the secured storage region.

On the other hand, the image data 62 is not always the image data ranging over the whole region of the set paper size at the time of printing. For example, the case where the image data 62 is the image data falling into a half page of the predetermined paper size exists.

If the image data 62 including the image data falling into the half page of the predetermined paper size is copied into the storage region secured correspondingly to the predetermined paper size, a half of the secured storage region of the local memory 28A shown in FIG. 13 on the right side thereof becomes a useless region to be unused.

Accordingly, the DSP 28 secures the storage region of the local memory 28A corresponding to the paper size necessary for forming an image based on the image data 62. For example, if the image data 62 is the image data falling in a half page of a predetermined paper size when the predetermined paper size (e.g. A4) is set, the DSP 28 secures the storage region of the local memory 28A corresponding to a half paper size (e.g. A5) of the predetermined paper size.

Hereby, the conventional problem of being unable to effectively utilize the local memory 28A owing to the occurrence of a useless space produced in the local memory 28A because an image rendered on the basis of the image data 62 is smaller than a predetermined paper size when the storage region of the local memory 28A is secured correspondingly to a set paper size can be solved, and the more storage region of the local memory 28A can effectively be utilized for the processing performed by the DSP 28.

Although the aforesaid example describes about the predetermined paper size (e.g. A4) and the half paper size (e.g. A5) of the predetermined paper size, similar processing can be preformed to the other paper sizes. Furthermore, the ratio of paper sizes is not limited to ½. For example, if the image data 62 is the image data falling in a quarter of a predetermined paper size (e.g. A3) when the predetermined paper size is set, the DSP 28 secures the storage region of the local memory 28A corresponding to the paper size (e.g. A5) meeting the quarter of the predetermined paper size. The other ratios can similarly be used.

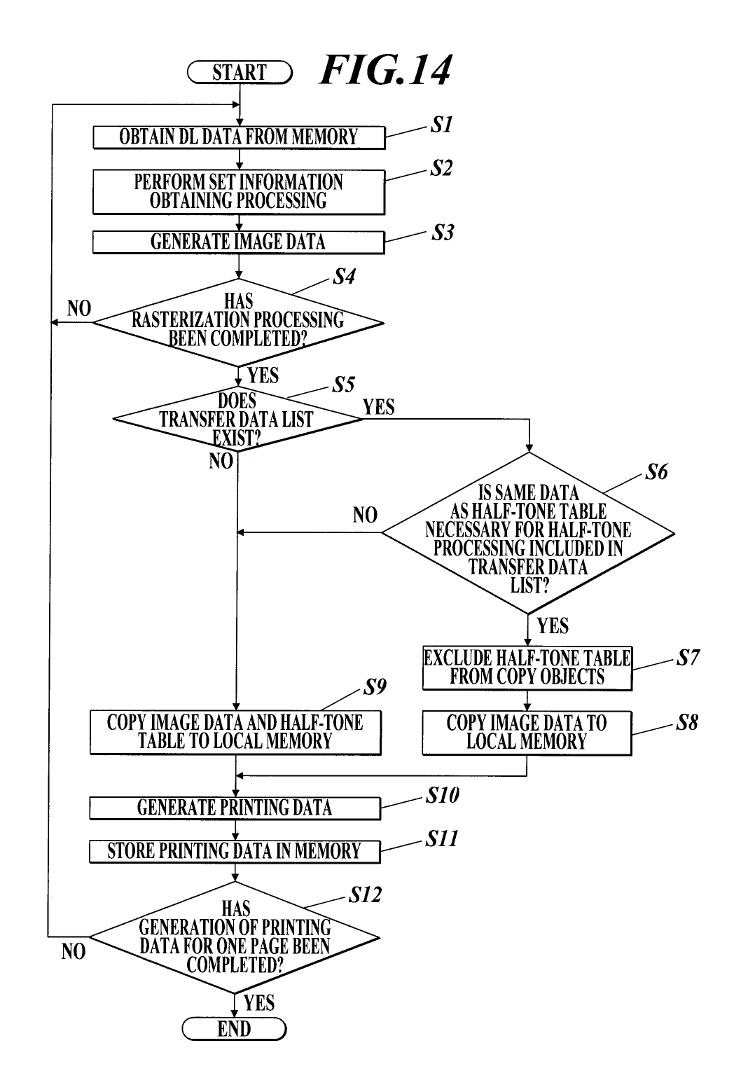

Next, the flows of rasterization processing and half-tone processing by the image forming apparatus 1 will be described with reference to the flow charts of FIGS. 14-17.

FIG. 14 shows a flow of rasterization processing and half-tone processing including the copying control processing of the half-tone table 64 on the basis of the transfer data list 65.

The CPU 21 obtains the DL data 61 from the memory 54 (Step S1), and performs set information obtaining processing (Step S2) to generate the image data 62 (Step S3). The CPU 21 judges whether rasterization processing based on all pieces of the DL data 61 for generating the image data 62 has been completed or not (Step S4). If the rasterization processing based on all pieces of the DL data 61 for generating the image data 62 has not been completed (Step S4: NO), the processing returns to that at Step S1.

If the rasterization processing based on all pieces of the DL data 61 for generating the image data 62 has been completed at Step S4 (Step S4: YES), the CPU 21 judges whether the transfer data list 65 exists or not (Step S5). If the transfer data list 65 exists (Step S5: YES), the CPU 21 reads out the transfer data list 65 and judges whether the same data as the half-tone table 64 to be used for the image data 62 of the object of the half-tone processing to be performed from now on is included in the transfer data list 65 or not (Step S6).

If the same data as the half-tone table 64 to be used for the image data 62 of the object of the half-tone processing to be performed from now on is included in the transfer data list 65 at Step S6 (Step S6: YES), the CPU 21 excludes the half-tone table 64 from the copy objects (Step S7) and only outputs the memory address of the image data 62. The DSP 28 copies the image data 62 into the local memory 28A on the basis of the memory address output from the CPU 21 (Step S8).

If the transfer data list 65 does not exists at Step S5 (Step S5: NO), or if the same data as the half-tone table 64 to be used for the image data 62 of the object of the half-tone processing to be performed from now on is not included in the transfer data list 65 at Step S6 (Step S6: NO), then the CPU 21 outputs the memory address of the image data 62 and the memory address of the half-tone table 64. The DSP 28 copies the image data 62 and the half-tone table 64 to the local memory 28A on the basis of the memory addresses output from the CPU 21 (Step S9).

After the processing at Step S8 or Step S9, the DSP 28 generates the printing data 63 (Step S10). Then, the DSP 28 stores the printing data 63 generated at Step S10 into the memory 54 (Step S11). Then, the DSP 28 informs the rendering processing section 53 of the completion of the half-tone processing. The CPU 21 judges whether the generation of the printing data 63 for one page has been completed or not (Step S12). If the generation of the printing data 63 for one page has been completed (Step S12: YES), the processing ends. If the generation of the printing data 63 for one page has not been completed (Step S12: NO), the processing returns to that at Step S1.

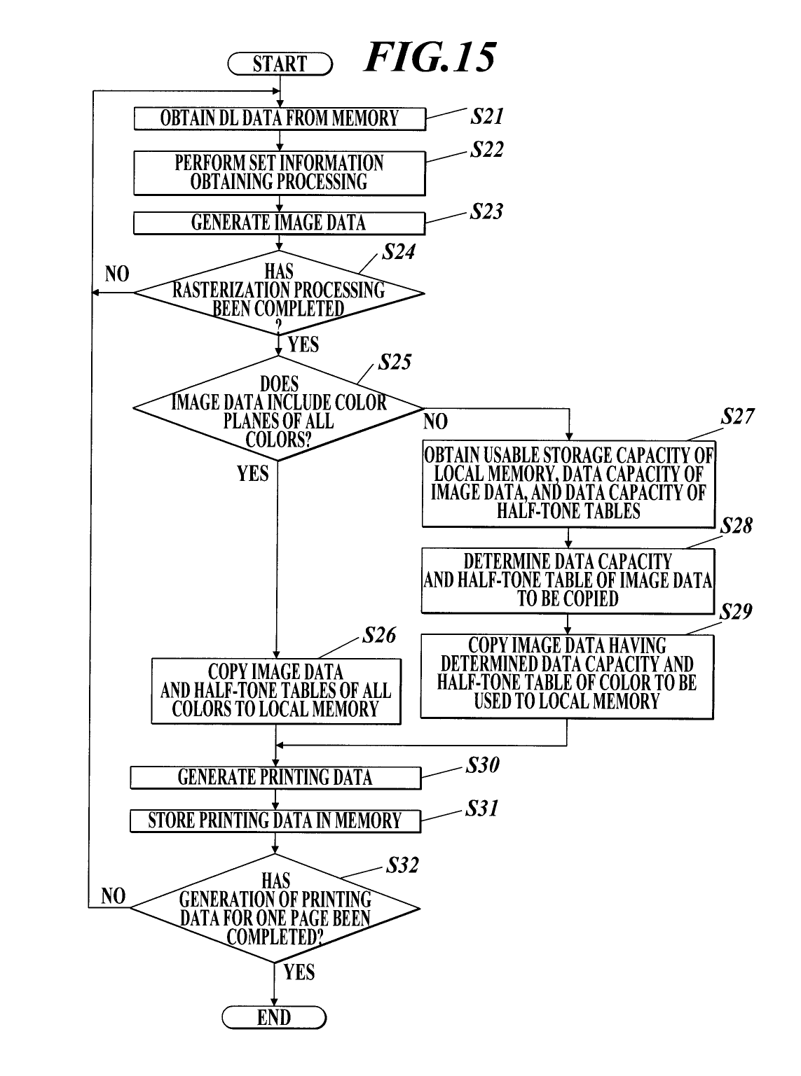

FIG. 15 shows a flow of rasterization processing and half-tone processing including the copying control processing of the half-tone table 64 based on the color information of the image data 62.

The CPU 21 obtains the DL data 61 from the memory 54 (Step S21) and performs set information obtaining processing (Step S22) to generate the image data 62 (Step S23). The CPU 21 judges whether the rasterization processing based on all pieces of the DL data 61 for generating the image data 62 has been completed or not (Step S24). If the rasterization processing based on all pieces of the DL data 61 for generating the image data 62 has not been completed (Step S24: NO), the processing returns to that at Step S21.

If the rasterization processing based on all pieces of the DL data 61 for generating the image data 62 is completed at Step S24 (Step S24: YES), the CPU 21 judges whether the image data 62 of the object of the half-tone processing includes the color planes of all colors or not (Step S25). If the image data 62 includes the color planes of all colors (Step S25: YES), the CPU 21 outputs the memory address of the image data 62 and the memory address of the half-tone table 64 corresponding to all pieces of color information to the DSP 28. The DSP 28 copies the image data 62 and the half-tone table 64 to the local memory 28A on the basis of the memory addresses output from the CPU 21 (Step S26).

If the image data 62 does not include the color planes of all colors at Step S25 (Step S25: NO), the CPU 21 obtains the usable storage capacity of the local memory 28A through the DSP 28 and obtains the pieces of data capacity of the image data 62 and the half-tone table 64 (Step S27). The CPU 21 determines the data capacity of the image data 62 of the copy object and the half-tone table 64 on the basis of the usable storage capacity of the local memory 28A obtained at Step S27 (Step S28). The CPU 21 outputs the memory address of the image data 62 of the determined data capacity and the memory address corresponding to the half-tone table 64 corresponding to the color plane of the image data 62 to the DSP 28. The DSP 28 copies the image data 62 and the half-tone table 64 corresponding to the color plane of the image data 62 to the local memory 28A on the basis of the memory addresses output from the CPU 21 (Step S29).

After the processing at Step S26 or S29, the DSP 28 generates the printing data 63 (Step S30). Then, the DSP 28 stores the printing data 63 generated at Step S30 into the memory 54 (Step S31). Then, the DSP 28 informs the rendering processing section 53 of the completion of the half-tone processing. The CPU 21 judges whether the generation of the printing data 63 for one page has been completed or not (Step S32). If the generation of the printing data 63 for one page has been completed (Step S32: YES), the processing ends. If the generation of the printing data 63 for one page has not been completed (Step S32: NO), the processing returns to that at Step S21.

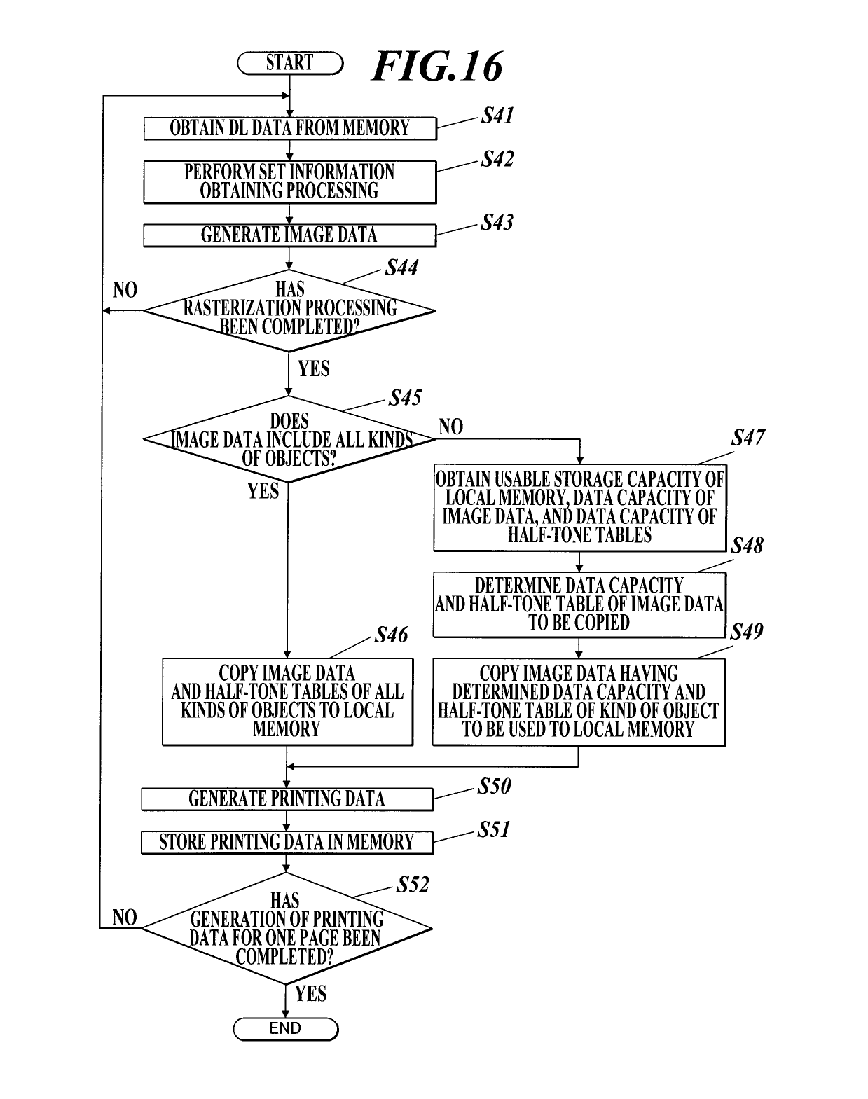

FIG. 16 shows rasterization processing and half-tone processing including the copying control processing of the half-tone table 64 based on the kind of object of the image data 62.

The CPU 21 obtains the DL data 61 from the memory 54 (Step S41) and performs set information obtaining processing (Step S42) to generate the image data 62 (Step S43). The CPU 21 judges whether the rasterization processing based on all pieces of the DL data 61 for generating the image data 62 has been completed or not (Step S44). If the rasterization processing based on all pieces of the DL data 61 for generating the image data 62 has not been completed (Step S44: NO), the processing returns to that at Step S41.

If the rasterization processing based on all pieces of the DL data 61 for generating the image data 62 has been completed at Step S44 (Step S44: YES), the CPU 21 judges whether the image data 62 of the object of the half-tone processing includes all the kinds of objects or not (Step S45). If the image data 62 includes all the kinds of objects (Step S45: YES), the CPU 21 outputs the memory address of the image data 62 and the memory address of the half-tone table 64 corresponding to all the kinds of objects to the DSP 28. The DSP 28 copies the image data 62 and the half-tone table 64 to the local memory 28A on the basis of the memory addresses output from the CPU 21 (Step S46).

If the image data 62 does not include all the kinds of objects at Step S45 (Step S45: NO), the CPU 21 obtains the usable storage capacity of the local memory 28A through the DSP 28 and obtains the pieces of data capacity of the image data 62 and the half-tone table 64 (Step S47). The CPU 21 determines the data capacity of the image data 62 of the copy object and the half-tone table 64 on the basis of the usable storage capacity of the local memory 28A obtained at Step S47 (Step S48). The CPU 21 outputs the memory address of the image data 62 of the determined data capacity and the memory address corresponding to the half-tone table 64 corresponding to the kind of object to the DSP 28. The DSP 28 copies the image data 62 and the half-tone table 64 corresponding to the kind of object to the local memory 28A on the basis of the memory addresses output from the CPU 21 (Step S49).

After the processing at Step S46 or S49, the DSP 28 generates the printing data 63 (Step S50). Then, the DSP 28 stores the printing data 63 generated at Step S50 into the memory 54 (Step S51). Then, the DSP 28 informs the rendering processing section 53 of the completion of the half-tone processing. The CPU 21 judges whether the generation of the printing data 63 for one page has been completed or not (Step S52). If the generation of the printing data 63 for one page has been completed (Step S52: YES), the processing ends. If the generation of the printing data 63 for one page has not been completed (Step S52: NO), the processing returns to that at Step S41.

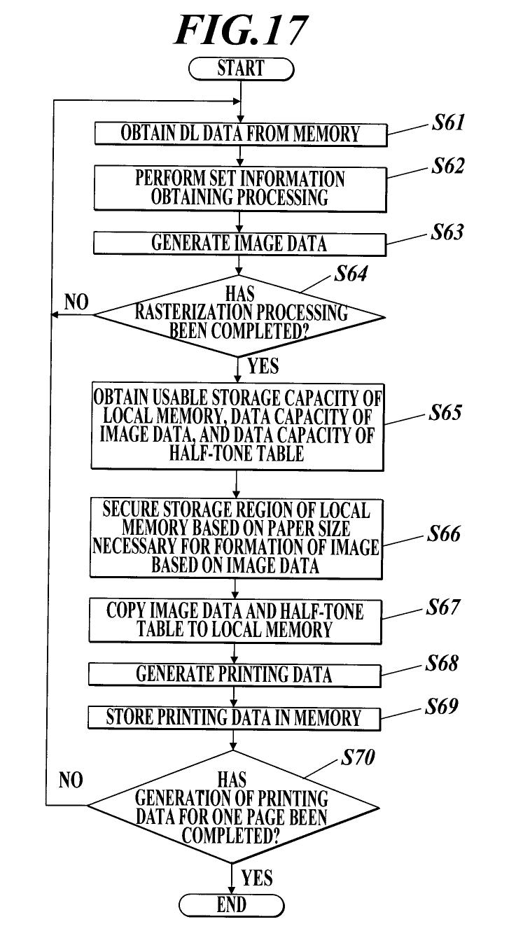

FIG. 17 shows a flow of rasterization processing and half-tone processing including the processing of securing the storage region of the local memory 28A corresponding to the paper size necessary for forming an image based on the image data 62.

The CPU 21 obtains the DL data 61 from the memory 54 (Step S61) and performs set information obtaining processing (Step S62) to generate the image data 62 (Step S63). The CPU 21 judges whether the rasterization processing based on all pieces of the DL data 61 for generating the image data 62 has been completed or not (Step S64). If the rasterization processing based on all pieces of the DL data 61 for generating the image data 62 has not been completed (Step S64: NO), the processing returns to that at Step S61.

If the rasterization processing based on all pieces of the DL data 61 for generating the image data 62 has been completed at Step S64 (Step S64: YES), the CPU 21 obtains the usable storage capacity of the local memory 28A through the DSP 28 and obtains the paper size necessary for forming an image based on the image data 62 and the pieces of data capacity of the image data 62 and the half-tone table 64 (Step S65). The CPU 21 secures the storage region of the local memory 28A on the basis of the paper size necessary for forming the image based on the obtained image data 62 at Step S65 (Step S66). The CPU 21 outputs the memory address of the image data 62 of the determined data capacity and the memory address corresponding to the half-tone table 64 to the DSP 28. The DSP 28 copies the image data 62 and the half-tone table 64 to the local memory 28A on the basis of the memory addresses output from the CPU 21 (Step S67).

After the processing at Step S67, the DSP 28 generates the printing data 63 (Step S68). Then, the DSP 28 stores the printing data 63 generated at Step S68 into the memory 54 (Step S69). Then, the DSP 28 informs the rendering processing section 53 of the completion of the half-tone processing. The CPU 21 judges whether the generation of the printing data 63 for one page has been completed or not (Step S70). If the generation of the printing data 63 for one page has been completed (Step S70: YES), the processing ends. If the generation of the printing data 63 for one page has not been completed (Step S70: NO), the processing returns to that at Step S61.

In the above, the case where the half-tone table 64 to be used for half-tone processing includes the half-tone table 64 stored in the local memory 28A or is the same one as the latter, the case of only using the half-tone table 64 corresponding to the color plane of the image data 62, and the case of only using the half-tone table 64 corresponding to the kind of object of the image data 62 have individually been described, but these pieces of processing may be combined with one another. For example, if half-tone processing is performed to the image data 62 having the color planes of two colors, the half-tone processing may be adapted to only copy the half-tone table 64 corresponding to the color that is not stored in the local memory 28A when the half-tone table 64 corresponding to the color plane of one color has already been stored in the local memory 28A between the half-tone tables 64 corresponding to the color planes. The situation is similar to the half-tone processing concerning the kinds of objects. Furthermore, the half-tone processing may be adapted to only copy the half-tone table 64 corresponding to a part of colors and a specific kind of object to the image data 62 limited to the color and the kind of object.

According to the present embodiment, if the half-tone table 64 stored in the local memory 28A and the half-tone table 64 corresponding to the image data 62 of the object of half-tone processing are included or are the same ones, the CPU 21 only outputs the memory address of the image data 62. At this time, the DSP 28 only obtains the image data 62 to copy the obtained image data 62 to the local memory 28A and performs the half-tone processing with reference to the half-tone table already stored in the local memory 28A. Hereby, the traffic of data and the data transfer time for obtaining the half-tone table 64 can be curtailed, and the processing time required for the half-tone processing can be shortened. Namely, the increase of the speed of half-tone processing can be realized, and the image processing coping with both of the reduction of costs by adopting the DSP 28 and the increase of the speed of processing can be realized.

Furthermore, the CPU 21 generates the transfer data list 65 at the time of outputting a memory address to the DSP 28 and judges whether the half-tone table 64 stored in the local memory 28A and the half-tone table 64 corresponding to the image data 62 of the object of half-tone processing are included or not, or whether the half-tone tables are the same or not. Hereby, the processing for checking the content stored in the local memory 28A can be made to be unnecessary at the time of judging whether the half-tone table 64 stored in the local memory 28A and the half-tone table 64 corresponding to the image data 62 of the object of the half-tone processing are included or not, or whether the half-tone tables 64 are the same or not, and consequently the time required for the judgment processing can be shortened. Because the judgment is performed as one process of the half-tone processing, the increase of the speed of the half-tone processing can be realized by the shortening of the judgment.

Furthermore, the DSP 28 adjusts the quota of the storage capacity for storing the half-tone table 64 in the local memory 28A correspondingly to the data quantities of the image data 62 and the half-tone table 64 copied from the memory 54 on the basis of the memory addresses input from the CPU 21.

Hereby, the adjustment of the quota of the storage capacity of the local memory 28A can be performed correspondingly to the data capacity of the half-tone table 64. Consequently, the adjustment of the quota of the storage capacity of the local memory 28A can flexibly be performed according to the size of the data quantity of the half-tone table 64, and the local memory 28A can effectively be utilized without forming useless vacant capacity in the storage region thereof. Hereby, the capacity of the image data 62 for which half-tone processing can be performed by the command for performing the half-tone processing can be made to be large, and the number of times of data transfers between the memory 54 and the local memory 28A in the processing of generating the printing data 63 by repeating a plurality of times of half-tone processing can be reduced. Namely, the overhead accompanying the command for performing the half-tone processing and the data transfer accompanying the half-tone processing can be reduced, and the image processing coping with both the reduction of the costs of adopting the DSP 28 and the increase of the speed of the processing of image processing can be realized.

Furthermore, the half-tone table 64 is individually provided correspondingly to the combinations of the respective attributes of the kinds of objects and the color information, and the CPU 21 outputs the memory address of the image data 62 and the memory address of only the half-tone table 64 that becomes necessary correspondingly to the kind of object and the color plane of the image data 62 to the DSP 28.

Hereby, the quota of the storage capacity of the local memory 28A can be adjusted on the basis of the minimum necessary data capacity of the half-tone table 64 corresponding to the kind of object and the color plane of the image data 62.

Furthermore, the memory address of the image data 62 of the object of the half-tone processing and the memory address of only the half-tone table 64 corresponding to the color information of the image data 62 are output to the DSP 28. The DSP 28 copies the image data 62 of the object of half-tone processing and only the half-tone table 64 corresponding to the kind of the object of the image data 62 to the local memory 28A, and thereby reduces the quota of the storage capacity of the local memory 28A for storing the half-tone table 64. Then, the DSP 28 assigns the part of the storage capacity of the local memory 28A which part corresponds to the reduced amount of the quota of the storage capacity of the local memory 28A for storing the half-tone table 64 to the reading of the image data 62 and the storage of the generated printing data 63.

Hereby, the capacity of the image data 62 for which the half-tone processing can be performed at a stretch can be made to be larger than that in the case of performing the half-tone processing requiring the half-tone table 64 of all colors. Consequently, the capacity of the image data 62 for which the half-tone processing can be performed by the command for performing the half-tone processing can be made to be large, and the number of the times of data transfers between the memory 54 and the local memory 28A in the processing of generating the printing data 63 by repeating a plurality of times of half-tone processing can be reduced. Namely, the overhead accompanying the command for performing half-tone processing and the data transfer accompanying the half-tone processing can be reduced.

In addition, the traffic of data between the memory 54 and the local memory 28A can be reduced by not transferring the unnecessary half-tone table 64.

Furthermore, the memory address of the image data 62 of the object of the half-tone processing and the memory address of only the half-tone table 64 corresponding to the kind of object of the image data 62 are output to the DSP 28. The DSP 28 copies the image data 62 of the object of the half-tone processing and only the half-tone table 64 corresponding to the kind of the object of the image data 62 to the local memory 28A, and thereby the quota of the storage capacity of the local memory 28A for storing the half-tone table 64 is reduced. Then, the DSP 28 assigns the part of the storage capacity of the local memory 28A which part corresponds to the reduced amount of the quota of the storage capacity of the local memory 28A for storing the half-tone table 64 to the reading of the image data 62 and the storage of the generated printing data 63.

Hereby, the capacity of the image data 62 for which the half-tone processing can be performed at a stretch can be made to be larger than that in the case of performing the half-tone processing requiring the half-tone table 64 corresponding to all kinds of objects. Consequently, the capacity of the image data 62 for which the half-tone processing can be performed by the command for performing the half-tone processing can be made to be large, and the number of the times of data transfers between the memory 54 and the local memory 28A in the processing of generating the printing data 63 by repeating a plurality of times of half-tone processing can be reduced. Namely, the overhead accompanying the command for performing half-tone processing and the data transfer accompanying the half-tone processing can be reduced.

In addition, the traffic of data between the memory 54 and the local memory 28A can be reduced by not transferring the unnecessary half-tone table 64.

Incidentally, the embodiment of the present invention disclosed in this description should be regarded as an example in all respects thereof and as being not restrictive. The scope of the present invention is shown not by the above description but by the claims, and all modifications equivalent to the claims and within the scope of the claims are intended to be included in the scope of the present invention.

For example, in the embodiment described above, the CPU included in the configuration of the image forming apparatus reads software from the ROM or the storage device, to execute and process the read software, thereby functions as an image processing device. However, an independent image processing apparatus may alternatively be provided separately from the image forming apparatus.

The color spaces constituting the color planes of image data to be subjected to the half-tone processing of the image data or the like are not limited to the colors C, M, Y, and K. For example, various color spaces, such as CMY, RGB, and sRGB, can be adopted as the attributes of the image data to be applied to the present invention.

Furthermore, the present invention may be applied in color management processing for converting the color space of image data.

For example, an International Color Consortium (ICC) profile, which is reference data to be used for color space conversion, is previously been stored in memory every color space, and the processing section, such as the CPU, outputs the memory addresses of image data and the ICC profile necessary for the color space conversion of the image data to another processing section, such as the DSP. Then, the other processing section, such as the DSP, copies image data and the ICC profile to the storage section, such as the local memory, according to the memory addresses to perform the color management processing. Hereby, the quota of the storage capacity can flexibly be adjusted also to the storage region of the storage section to be used for the color management processing, and the storage section can effectively be utilized.

The memory 54 of the aforesaid embodiment is the one comprehending the storage region of the RAM 22 and the storage region to be used as a virtual memory in the storage region of the storage device, but the memory 54 may be either of them, or a storage region of another storage device may be used as the memory 54.

In the aforesaid embodiment, although the DSP 28 performs the processing of copying the printing data 63 generated by the DSP 28 into the memory 54 as the main body, the rendering processing section 53, i.e. the CPU 21, may perform the processing of copying as the main body.

It is possible to provide a plurality of DSPs 28. Hereby, the plurality of DSPs 28 can perform half-tone processing in parallel to shorten the processing time required by the half-tone processing.

According to a first aspect of the preferred embodiment of the present invention, provided is an image processing apparatus to generate printing data based on image data, comprising:

a storage section to store the image data and reference data necessary for processing of generating the printing data;

a printing data generating section to generate the printing data based on the image data and the reference data; and

a control section to output an address of the image data in the storage section and an address of the reference data in the storage section to the printing data generating section, wherein

the printing data generating section obtains the image data and the reference data based on the address of the image data and the address of the reference data, the address of the image data and the address of the reference data being output from the control section, and stores the obtained image data and the obtained reference data in an internal storage section of the printing data generating section, and

the control section outputs both of the address of the image data and the address of the reference data to the printing data generating section when storage content stored in the internal storage section does not include the reference data obtained based on the address of the reference data, and only outputs the address of the image data to the printing data generating section when the storage content stored in the internal storage section already includes the reference data obtained based on the address of the reference data.

According to the present embodiment, the CPU 21 only outputs the memory address of the image data 62 when the half-tone table 64 stored in the local memory 28A and the half-tone table 64 corresponding to the image data 62 of the object of half-tone processing are included or are the same. Hereby, the traffic of data and the data transfer time for obtaining the half-tone table 64 can be curtailed, and the processing time of the half-tone processing can be shortened. Namely, the increase of the speed of the half-tone processing can be realized, and the image processing capable of coping with both the reduction of costs by adopting the DSP 28 and the increase of the speed of processing can be realized.

Preferably, the control section outputs both of the address of the image data and the address of the reference data to the printing data generating section when the reference data stored in the internal storage section is not the same as the reference data obtained based on the address of the reference data, and only outputs the address of the image data to the printing data generating section when the reference data stored in the internal storage section is the same as the reference data obtained based on the address of the reference data.

According to the present embodiment, the DSP 28 only obtains the image data 62 to copy the obtained image data 62 to the local memory 28 and performs half-tone processing with reference to the half-tone table that has already been stored in the local memory 28A. Hereby, the traffic of data and the data transfer time for obtaining the half-tone table 64 can be curtailed, and the processing time required by the half-tone processing can be shortened. Namely, the increase of the speed of the half-tone processing can be realized, and the image processing coping with both the reduction of costs by adopting the DSP 28 and the increase of the speed of the processing can be realized.

Preferably, the control section generates management data for managing the data stored in the internal storage section, and judges whether the reference data stored in the internal storage section based on the management data and the reference data obtained based on the address of the reference data are the same or not.

According to the present embodiment, the processing for checking the content stored in the local memory 28A can be made to be unnecessary at the time of judging whether the half-tone table 64 stored in the local memory 28A and the half-tone table 64 corresponding to the image data 62 of the object of half-tone processing are included or not, or whether both the half-tone tables 64 are the same or not, and the time required for the judgment processing can be shortened. Because the judgment is performed as one process of the half-tone processing, the increase of the speed of the half-tone processing can be realized by shortening the judgment.

According to a second aspect of the preferred embodiment of the present invention, provided is an image processing apparatus to generate printing data based on image data, comprising:

a storage section to store the image data and reference data necessary for processing of generating the printing data;

a printing data generating section to generate the printing data based on the image data and the reference data; and

a control section to output an address of the image data in the storage section and an address of the reference data in the storage section to the printing data generating section, wherein

the printing data generating section obtains the image data and the reference data based on the address of the image data and the address of the reference data, the address of the image data and the address of the reference data being output from the control section, and stores the obtained image data and the obtained reference data in an internal storage section of the printing data generating section, and further adjusts a quota of a storage capacity for storing the reference data in the internal storage section based on data quantities of the image data and the reference data.

According to the present embodiment, the adjustment of the quota of the storage capacity of the local memory 28A can be performed according to the data capacity of the half-tone table 64. Consequently, the adjustment of the quota of the storage capacity of the local memory 28A can flexibly be performed according to the size of the data quantity of the half-tone table 64, and the storage region of the local memory 28A can effectively be utilized without forming any useless vacant capacity in the storage region. Hereby, the capacity of the image data 62 for which capacity half-tone processing can be performed by the command for performing the half-tone processing can be made to be large, and the number of the times of data transfers between the memory 54 and the local memory 28A in the processing of generating the printing data 63 by repeating a plurality of times of half-tone processing can be reduced. Namely, the overhead accompanying the command for performing the half-tone processing and the data transfer accompanying the half-tone processing can be reduced, and the image processing coping with both of the reduction of the costs by adopting the DSP 28 and the increase of the speed of the processing can be realized.

Preferably, the reference data is provided by each attribute of the image data, and

the control section outputs the address of the image data and the address of only the reference data corresponding to the attribute of the image data to the printing data generating section.

According to the present embodiment, the quota of the storage capacity of the local memory 28A can be adjusted on the basis of the minimum necessary data capacity of the half-tone table 64 corresponding to the kind of object and the color plane of the image data 62.

Preferably, the control section outputs the address of the image data and the address of only the reference data corresponding to color information of the image data to the printing data generating section.

According to the present embodiment, the capacity of the image data 62 for which capacity half-tone processing can be performed at a stretch can be made to be larger than that in the case of performing the half-tone processing requiring the half-tone table 64 of all colors. Consequently, the capacity of the image data 62 for which the half-tone processing can be performed by the command for performing the half-tone processing can be made to be large, and the number of the times of data transfers between the memory 54 and the local memory 28A in the processing of generating the printing data 63 by repeating a plurality of times of half-tone processing can be reduced. Namely, the overhead accompanying the command for performing the half-tone processing and the data transfer accompanying the half-tone processing can be reduced.

In addition, the traffic of data between the memory 54 and the local memory 28A can be reduced by not performing the transfer of the unnecessary half-tone table 64.

Preferably, the control section outputs the address of the image data and the address of only the reference data corresponding to a kind of rendering content rendered based on the image data to the printing data generating section.

According to the present embodiment, the capacity of the image data 62 for which half-tone processing can be performed at a stretch can be made to be larger than that in the case of performing the half-tone processing requiring the half-tone table 64 of all kinds of objects. Consequently, the capacity of the image data 62 for which capacity the half-tone processing can be performed by the command for performing the half-tone processing can be made to be large, and the number of the times of data transfers between the memory 54 and the local memory 28A in the processing of generating the printing data 63 by repeating a plurality of times of half-tone processing can be reduced. Namely, the overhead accompanying the command for performing the half-tone processing and the data transfer accompanying the half-tone processing can be reduced.

In addition, the traffic of data between the memory 54 and the local memory 28A can be reduced by not performing the transfer of the unnecessary half-tone table 64.

What is claimed is:

1. An image processing apparatus to generate printing data based on image data, comprising:
a storage section to store the image data and reference data necessary for processing of generating the printing data;
a printing data generating section to generate the printing data based on the image data and the reference data; and
a control section to output an address of the image data in the storage section and an address of the reference data in the storage section to the printing data generating section, wherein
the printing data generating section obtains the image data and the reference data based on the address of the image data and the address of the reference data, the address of the image data and the address of the reference data being output from the control section, and stores the obtained image data and the obtained reference data in an internal storage section of the printing data generating section, and
the control section outputs both of the address of the image data and the address of the reference data to the printing data generating section when storage content stored in the internal storage section does not include the reference data obtained based on the address of the reference data, and only outputs the address of the image data to the printing data generating section when the storage content stored in the internal storage section already includes the reference data obtained based on the address of the reference data.

2. The image processing apparatus as claimed in claim 1, wherein the control section outputs both of the address of the image data and the address of the reference data to the printing data generating section when the reference data stored in the internal storage section is not the same as the reference data obtained based on the address of the reference data, and only outputs the address of the image data to the printing data generating section when the reference data stored in the internal storage section is the same as the reference data obtained based on the address of the reference data.

3. The image processing apparatus as claimed in claim 2, wherein the control section generates management data for managing the data stored in the internal storage section, and judges whether the reference data stored in the internal storage section based on the management data and the reference data obtained based on the address of the reference data are the same or not.

4. An image processing apparatus to generate printing data based on image data, comprising:
a storage section to store the image data and reference data necessary for processing of generating the printing data;
a printing data generating section to generate the printing data based on the image data and the reference data; and
a control section to output an address of the image data in the storage section and an address of the reference data in the storage section to the printing data generating section, wherein
the printing data generating section obtains the image data and the reference data based on the address of the image data and the address of the reference data, the address of the image data and the address of the reference data being output from the control section, and stores the obtained image data and the obtained reference data in an internal storage section of the printing data generating section, and further adjusts a quota of a storage capacity for storing the reference data in the internal storage section based on data quantities of the image data and the reference data.

5. The image processing apparatus as claimed in claim 4, wherein the reference data is provided by each attribute of the image data, and
the control section outputs the address of the image data and the address of only the reference data corresponding to the attribute of the image data to the printing data generating section.

6. The image processing apparatus as claimed in claim 5, wherein the control section outputs the address of the image data and the address of only the reference data corresponding to color information of the image data to the printing data generating section.

7. The image processing apparatus as claimed in claim 5, wherein the control section outputs the address of the image data and the address of only the reference data corresponding to a kind of rendering content rendered based on the image data to the printing data generating section.
